(19) United States
(12) Patent Application Publication
(10) Pub. No.: US 2016/0077836 A1
(43) Pub. Date: Mar. 17, 2016

(54) PREDICTING LITERAL LOAD VALUES USING A LITERAL LOAD PREDICTION TABLE, AND RELATED CIRCUITS, METHODS, AND COMPUTER-READABLE MEDIA

(71) Applicant: QUALCOMM Incorporated, San Diego, CA (US)

(72) Inventor: Michael William Morrow, Wilkes Barre, PA (US)

(21) Appl. No.: 14/484,659

(22) Filed: Sep. 12, 2014

(51) Int. Cl. G06F 9/38

(52) U.S. Cl. CPC G06F 9/3861

(57) ABSTRACT

Predicting literal load values using a literal load prediction table, and related circuits, methods, and computer-readable media are disclosed. In one aspect, an instruction processing circuit provides a literal load prediction table containing one or more entries, each comprising an address and a literal load value. Upon detecting a literal load instruction in an instruction stream, the instruction processing circuit determines whether the literal load prediction table contains an entry having an address of the literal load instruction. If so, the instruction processing circuit provides the predicted literal load value stored in the entry to at least one dependent instruction. The instruction processing circuit subsequently determines whether the predicted literal load value matches the actual literal load value loaded by the literal load instruction. If a mismatch exists, the instruction processing circuit initiates a misprediction recovery. The at least one dependent instruction is re-executed using the actual literal load value.

### BACKGROUND

I. Field of the Disclosure

The technology of the disclosure relates generally to literal load instructions provided by a computer processor.

II. Background

Computer programs executed by modern computer processors may frequently employ literal values. As used herein, a “literal value” is a value that is expressed as itself (e.g., a numeral 25 or a string “Hello World”) in a computer program's source code. Literal values may provide a convenient means for a computer program to represent and utilize values that do not change or that change only rarely during execution of the computer program. Multiple literal values to be accessed during execution of the computer program may be stored together in memory as a block of data known as a “constant pool.”

A load instruction may be employed by a computer program to access a literal value located at a specified address (i.e., a “literal load value”), and to place the literal load value in a register for use by one or more subsequent instructions following the load instruction in a processing pipeline. Such load instructions are referred to herein as “literal load instructions,” while the subsequent instructions that make use of the literal load value as an input are referred to as “dependent instructions.” In some computer architectures, a literal load instruction may specify the location of the literal load value in a constant pool as an address relative to an address of the literal load instruction itself. For example, the following instructions illustrate a literal load instruction and a subsequent dependent instruction that may be used by an ARM architecture:

LDR R₀, [PC, #0x40]; retrieve the literal load value stored at program counter (PC)+0x40+8 into register R₀

ADD R₁, R₀, R₀; use the literal load value by adding the value in register R₀ to itself, and storing the result in register R₁.

However, due to data cache latency inherent in many conventional processors, a load instruction may incur a “load:use penalty” when loading a literal load value into a register. A load:use penalty refers to a minimum number of processor cycles that may elapse between dispatching of the load instruction and dispatching of a subsequent dependent instruction attributable to data cache latency. For instance, in the exemplary code above, the ADD instruction cannot be dispatched until the load:use penalty incurred by the LDR instruction has elapsed. Because the dependent instruction cannot be dispatched until the load instruction returns data, the load:use penalty may result in a “bubble” of underutilized processor cycles occurring within a processing pipeline.

### SUMMARY OF THE DISCLOSURE

Aspects disclosed in the detailed description include predicting literal load values using a literal load prediction table. Related circuits, methods, and computer-readable media are also disclosed. In this regard, in one aspect, an instruction processing circuit provides a literal load prediction table used for generating predictions of literal load values and for detecting literal load value mispredictions. The literal load prediction table contains one or more entries, each comprising an address and a predicted literal load value. Upon detecting a literal load instruction in an instruction stream, the instruction processing circuit determines whether the literal load prediction table contains an entry having an address corresponding to the literal load instruction. If so, the instruction processing circuit provides the predicted literal load value stored in the entry to at least one dependent instruction. When the literal load instruction actually executes, the instruction processing circuit determines whether the predicted literal load value previously provided to the at least one dependent instruction matches the actual literal load value loaded by the literal load instruction. If the predicted literal load value and the actual literal load value do not match, the instruction processing circuit initiates a misprediction recovery. In some aspects, the misprediction recovery may include updating the entry with the actual literal load value, flushing the entry from the literal load prediction table, and/or setting a do-not-predict indicator in the entry. The at least one dependent instruction may then be re-executed using the actual literal load value. In this manner, the instruction processing circuit may enable dependent instructions to access literal load values without incurring a load:use penalty, thus providing improved processor utilization.

In another aspect, an instruction processing circuit is provided. The instruction processing circuit is configured to detect, in an instruction stream, a first occurrence of a literal load instruction. The instruction processing circuit is further configured to determine whether an address of the literal load instruction is present in an entry of a literal load prediction table. The instruction processing circuit is also configured to, responsive to determining that the address of the literal load instruction is present in the entry, provide a predicted literal load value stored in the entry for execution of at least one dependent instruction on the literal load instruction. The instruction processing circuit is additionally configured to, further responsive to determining that the address of the literal load instruction is present in the entry, determine, upon execution of the literal load instruction, whether the predicted literal load value matches an actual literal load value loaded by the literal load instruction. The instruction processing circuit is further configured to, responsive to determining that the predicted literal load value does not match the actual literal load value, initiate a misprediction recovery, and re-execute the at least one dependent instruction using the actual literal load value.

In another aspect, an instruction processing circuit is provided. The instruction processing circuit comprises a means for detecting, in an instruction stream, a first occurrence of a literal load instruction. The instruction processing circuit further comprises a means for determining whether an address of the literal load instruction is present in an entry of a literal load prediction table. The instruction processing circuit also comprises a means for, responsive to determining that the address of the literal load instruction is present in the entry, providing a predicted literal load value stored in the entry for execution of at least one dependent instruction on the literal load instruction. The instruction processing circuit additionally comprises a means for, further responsive to determining that the address of the literal load instruction is present in the entry, determining, upon execution of the literal load instruction, whether the predicted literal load value matches an actual literal load value loaded by the literal load instruction. The instruction processing circuit further comprises a means for, responsive to determining that the predicted literal load value does not match the actual literal load value, initiating a misprediction recovery. The instruction processing circuit also comprises a means for, further responsive to determining that the predicted literal load value does not match the actual literal load value, re-executing the at least one dependent instruction using the actual literal load value.

In another aspect, a method for predicting values of literal loads is provided. The method comprises detecting, in an instruction stream, a first occurrence of a literal load instruction. The method further comprises determining whether an address of the literal load instruction is present in an entry of a literal load prediction table. The method also comprises, responsive to determining that the address of the literal load instruction is present in the entry, providing a predicted literal load value stored in the entry for execution of at least one dependent instruction on the literal load instruction. The method additionally comprises, further responsive to determining that the address of the literal load instruction is present in the entry, determining, upon execution of the literal load instruction, whether the predicted literal load value matches an actual literal load value loaded by the literal load instruction. The method further comprises, responsive to determining that the predicted literal load value does not match the actual literal load value, initiating a misprediction recovery, and re-executing the at least one dependent instruction using the actual literal load value.

In another aspect, a non-transitory computer-readable medium is provided, having stored thereon computer-executable instructions to cause a processor to detect, in an instruction stream, a first occurrence of a literal load instruction. The computer-executable instructions stored thereon further cause the processor to determine whether an address of the literal load instruction is present in an entry of a literal load prediction table. The computer-executable instructions stored thereon also cause the processor to, responsive to determining that the address of the literal load instruction is present in the entry, provide a predicted literal load value stored in the entry for execution of at least one dependent instruction on the literal load instruction. The computer-executable instructions stored thereon additionally cause the processor to, further responsive to determining that the address of the literal load instruction is present in the entry, determine, upon execution of the literal load instruction, whether the predicted literal load value matches an actual literal load value loaded by the literal load instruction. The computer-executable instructions stored thereon further cause the processor to, responsive to determining that the predicted literal load value does not match the actual literal load value, initiate a misprediction recovery, and re-execute the at least one dependent instruction using the actual literal load value.

### BRIEF DESCRIPTION OF THE FIGURES

FIG. 1 is a block diagram of an exemplary computer processor including an instruction processing circuit for predicting literal load values and detecting literal load value mispredictions using a literal load prediction table;

FIGS. 2A-2C illustrate exemplary communications flows for establishing an entry in the literal load prediction table of FIG. 1, providing a predicted literal load value of the entry to a dependent instruction, and handling a literal load value misprediction by the instruction processing circuit of FIG. 1;

FIG. 3 is a flowchart illustrating exemplary operations for predicting literal load values and detecting mispredictions using the literal load prediction table of the instruction processing circuit of FIG. 1;

FIG. 4 is a chart illustrating exemplary operations for initiating a misprediction recovery in some aspects of the instruction processing circuit of FIG. 1;

FIG. 5 is a flowchart illustrating operations for using a do-not-predict indicator of the literal load prediction table in some aspects of the instruction processing circuit of FIG. 1; and

FIG. 6 is a block diagram of an exemplary processor-based system that can include the instruction processing circuit of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include predicting literal load values using a literal load prediction table. Related circuits, methods, and computer-readable media are also disclosed. In this regard, in one aspect, an instruction processing circuit provides a literal load prediction table used for generating predictions of literal load values and for detecting literal load value mispredictions. The literal load prediction table contains one or more entries, each comprising an address and a predicted literal load value. Upon detecting a literal load instruction in an instruction stream, the instruction processing circuit determines whether the literal load prediction table contains an entry having an address corresponding to the literal load instruction. If so, the instruction processing circuit provides the predicted literal load value stored in the entry to at least one dependent instruction. When the literal load instruction actually executes, the instruction processing circuit determines whether the predicted literal load value previously provided to the at least one dependent instruction matches the actual literal load value loaded by the literal load instruction. If the predicted literal load value and the actual literal load value do not match, the instruction processing circuit initiates a misprediction recovery. In some aspects, the misprediction recovery may include updating the entry with the actual literal load value, flushing the entry from the literal load prediction table, and/or setting a do-not-predict indicator in the entry. The at least one dependent instruction may then be re-executed using the actual literal load value. In this manner, the instruction processing circuit may enable dependent instructions to access literal load values without incurring a load:use penalty, thus providing improved processor utilization.

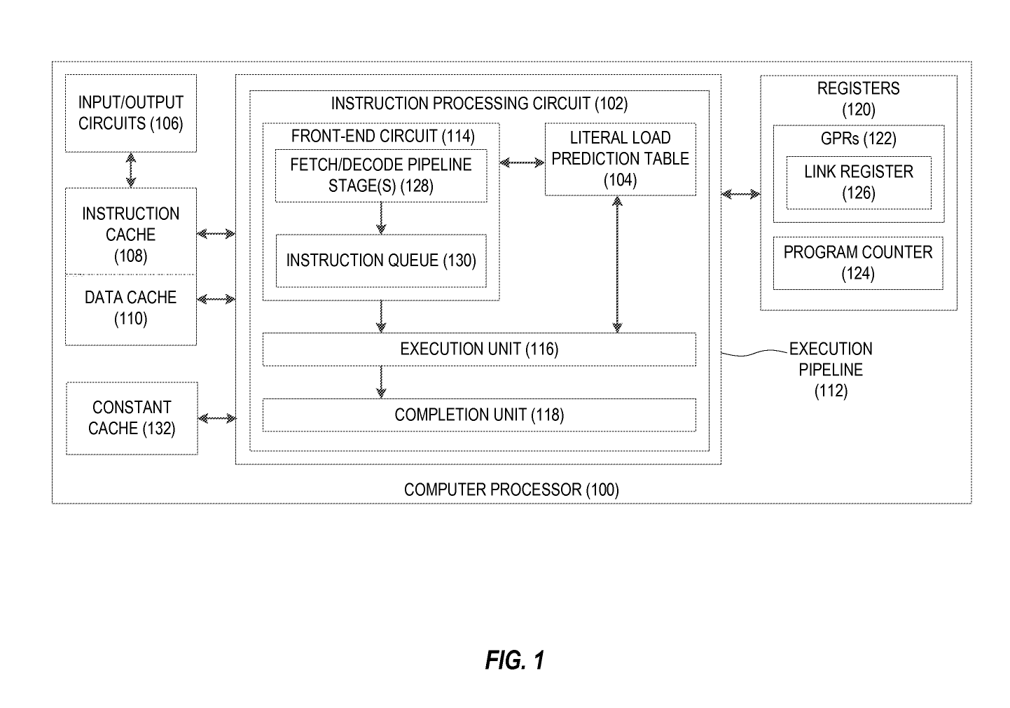

In this regard, FIG. 1 is a block diagram of an exemplary computer processor 100. The computer processor 100 includes an instruction processing circuit 102 providing a literal load prediction table 104 for predicting literal load values and detecting literal load value mispredictions, as disclosed herein. The computer processor 100 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages.

The computer processor 100 includes input/output circuits 106, an instruction cache 108, and a data cache 110. The computer processor 100 further comprises an execution pipeline 112, which includes a front-end circuit 114, an execution unit 116, and a completion unit 118. The computer processor 100 additionally includes registers 120, which comprise one or more general purpose registers (GPRs) 122, a program counter 124, and a link register 126. In some aspects, such as those employing the ARM® ARM7™ architecture, the link register 126 is one of the GPRs 122, as shown in FIG. 1. Alternately, some aspects, such as those utilizing the IBM® PowerPC® architecture, may provide that the link register 126 is separate from the GPRs 122 (not shown).

In exemplary operation, the front-end circuit 114 of the execution pipeline 112 fetches instructions (not shown) from the instruction cache 108, which in some aspects may be an on-chip Level 1 (L1) cache, as a non-limiting example. The fetched instructions are decoded by the front-end circuit 114 and issued to the execution unit 116. The execution unit 116 executes the issued instructions, and the completion unit 118 retires the executed instructions. In some aspects, the completion unit 118 may comprise a write-back mechanism (not shown) that stores the execution results in one or more of the registers 120. It is to be understood that the execution unit 116 and/or the completion unit 118 may each comprise one or more sequential pipeline stages. In the example of FIG. 1, the front-end circuit 114 comprises one or more fetch/decode pipeline stages 128, which enable multiple instructions to be fetched and decoded concurrently. An instruction queue 130 for holding the fetched instructions pending dispatch to the execution unit 116 is communicatively coupled to one or more of the fetch/decode pipeline stages 128.

The computer processor 100 of FIG. 1 further provides a constant cache 132 that is communicatively coupled to one or more elements of the execution pipeline 112. The constant cache 132 provides a quick-access mechanism by which a value previously stored in one of the registers 120 may be provided to an instruction that uses the value as an input operand. The constant cache 132 may thus improve the performance of the computer processor 100 by providing access to stored values more quickly than the registers 120.

While processing instructions in the execution pipeline 112, the instruction processing circuit 102 may fetch and execute a literal load instruction (not shown) for loading a literal load value into one of the registers 120. Processing the literal load instruction thus may include retrieving the literal load value from the data cache 110. However, in doing so, the literal load instruction may incur a load:use penalty resulting from an inherent latency in accessing the data cache 110. For example, in some computer architectures, accessing the data cache 110 may require two to three processor cycles to complete. Consequently, the instruction processing circuit 102 may be unable to dispatch a subsequent dependent instruction (not shown) until the load:use penalty incurred by the literal load instruction has elapsed. This may result in underutilization of the computer processor 100 within the execution pipeline 112.

In this regard, the instruction processing circuit 102 of FIG. 1 provides the literal load prediction table 104 for minimizing load:use penalties by predicting literal load values for literal load instructions, providing the predicted literal load values to dependent instructions, and detecting literal load value mispredictions. The instruction processing circuit 102 is configured to detect literal load instructions (not shown) in an instruction stream (not shown) being processed within the execution pipeline 112. In some aspects, the instruction processing circuit 102 may be configured to detect literal load instructions based on an idiomatic form of a load instruction employed by the computer processor 100. As a non-limiting example, in a computer processor utilizing the ARM architecture, a literal load instruction may be detected by determining that the literal load instruction uses a program-counter-relative addressing mode, with the program counter offset specified by a constant.

As the literal load instruction is fetched by the front-end circuit 114 of the instruction processing circuit 102, the instruction processing circuit 102 consults the literal load prediction table 104. The literal load prediction table 104 contains one or more entries (not shown). Each entry may include an address of a previously-detected literal load instruction, and a predicted literal load value that was previously loaded by the literal load instruction corresponding to the address.

The instruction processing circuit 102 determines whether an address of the literal load instruction being fetched is present in an entry of the literal load prediction table 104. If the address of the literal load instruction is found (i.e., a “hit”), the instruction processing circuit 102 provides the literal load value from the entry to at least one dependent instruction as a predicted literal load value. In some aspects, the predicted literal load value may be provided to the at least one dependent instruction via the constant cache 132. In this manner, the at least one dependent instruction may obtain the predicted literal load value for the literal load instruction without incurring a corresponding load:use penalty.

Following a “hit,” the literal load instruction may eventually be executed by the execution unit 116 of the instruction processing circuit 102. When the literal load instruction is executed, the instruction processing circuit 102 compares the predicted literal load value provided to the at least one dependent instruction with the actual literal load value loaded by the literal load instruction upon execution. If the predicted literal load value does not match the actual literal load value, a literal load value misprediction has occurred. In response, the instruction processing circuit 102 initiates a misprediction recovery. Some aspects may provide that operations for the misprediction recovery include updating the entry in the literal load prediction table 104, flushing the entry from the literal load prediction table 104, and/or setting a do-not-predict flag (not shown) in the entry of the literal load prediction table 104. The at least one dependent instruction may then be re-executed using the actual literal load value.

According to some aspects disclosed herein, if the instruction processing circuit 102 detects a literal load instruction but does not find the address of the literal load instruction in an entry of the literal load prediction table 104, a “miss” occurs. In this case, the instruction processing circuit 102 may generate an entry in the literal load prediction table 104 corresponding to the literal load instruction upon execution of the literal load instruction. The generated entry includes the address of the literal load instruction, and stores the actual literal load value loaded by the literal load instruction as the predicted literal load value of the entry. Accordingly, if and when the literal load instruction is again detected by the instruction processing circuit 102, a “hit” in the literal load prediction table 104 may occur, and the predicted literal load value may be provided to a dependent instruction.

As noted above, in some aspects, the instruction processing circuit 102 may set a do-not-predict indicator (not shown) in an entry of the literal load prediction table 104 as part of a misprediction recovery. The do-not-predict indicator may be used by the instruction processing circuit 102 to identify load instructions that appear to be literal load instructions, but that are known or determined to load different values at different points during execution of a computer program. Accordingly, after detecting an apparent literal load instruction and determining that an address of the literal load instruction is present in an entry of the literal load prediction table 104, the instruction processing circuit 102 may check the do-not-predict indicator of the entry. If the do-not-predict indicator is set, the instruction processing circuit 102 may proceed with executing the literal load instruction without providing a predicted literal load value to a dependent instruction. This may ensure that the dependent instruction always receives the actual literal load value loaded by the literal load instruction, and may avoid the possibility of repeated mispredictions and associated performance degradation of the computer processor 100.

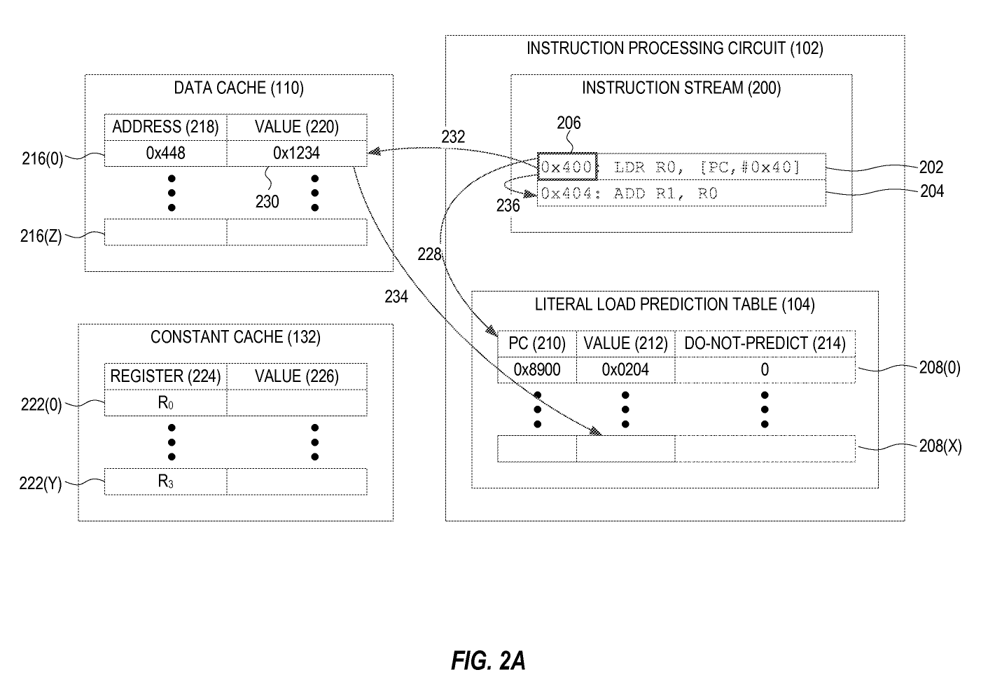

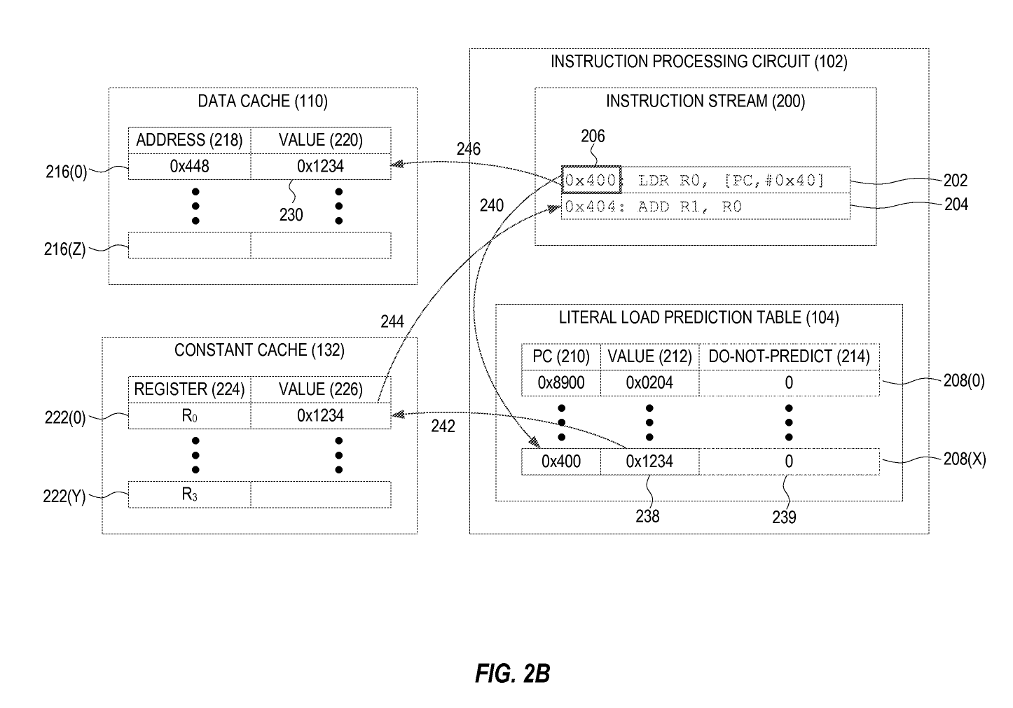

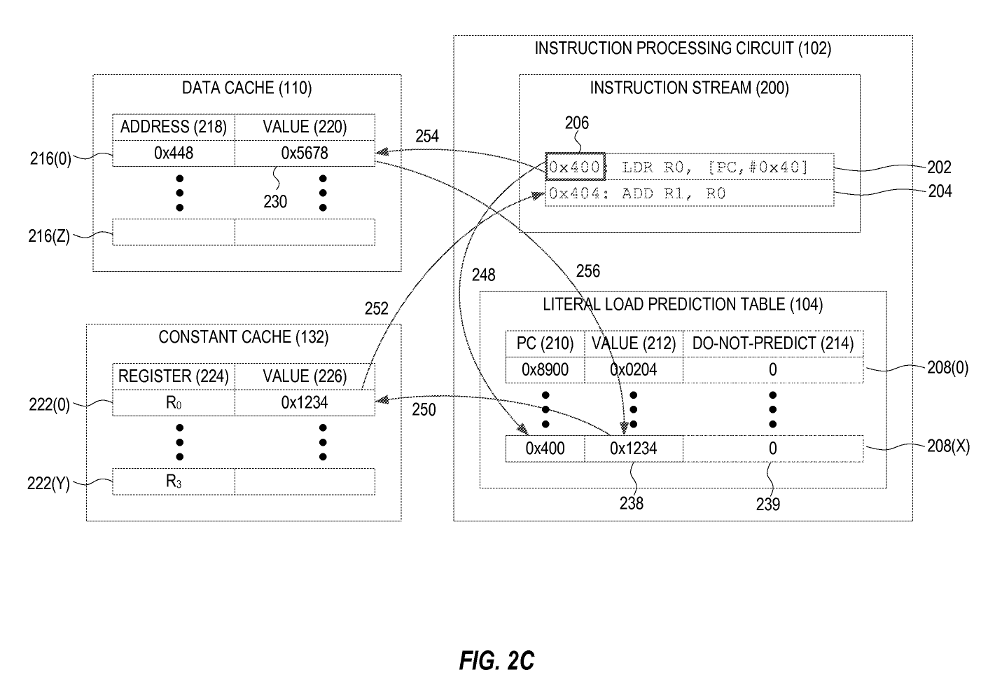

To better illustrate exemplary communications flows among the instruction processing circuit 102, the data cache 110, and the constant cache 132 of FIG. 1, FIGS. 2A-2C are provided. FIG. 2A illustrates exemplary communications flows for establishing an entry in the literal load prediction table 104, while FIG. 2B shows exemplary communications flows for providing a predicted literal load value of the entry to a dependent instruction. FIG. 2C illustrates exemplary communications flows for handling a literal load value misprediction.

In FIGS. 2A-2C, the instruction processing circuit 102 is processing an instruction stream 200 comprising two instructions: a literal load instruction 202 and a dependent instruction 204. The literal load instruction 202 is associated with an address 206, which in this example is the hexadecimal value 0x400. It is to be understood that, in some aspects, the address 206 may be retrieved from, e.g., the program counter 124 of FIG. 1. It is to be further understood that, while the instruction stream 200 of FIGS. 2A-2C includes only one dependent instruction 204, in some aspects the dependent instruction 204 may comprise multiple dependent instructions.

The literal load instruction 202 in this example is an LDR instruction, which directs the computer processor 100 to load a literal load value from an address specified by a current value of the program counter 124 (PC) plus the hexadecimal value 0x40. The literal load value is then stored in a register R₀, which may be one of the registers 120 of FIG. 1, as a non-limiting example. The dependent instruction 204 follows the literal load instruction 202 in the instruction stream 200, which in this example is an ADD instruction. The dependent instruction 204 receives the literal load value stored in the register R₀ as an input, and sums it with a value of a register R₁ (e.g., another one of the registers 120 of FIG. 1). The result is then stored in the register R₁.

The literal load prediction table 104 illustrated in FIGS. 2A-2C includes multiple entries 208(0)-208(X). To facilitate prediction of literal load values, each entry 208(0)-208(X) of the literal load prediction table 104 includes a program counter (PC) field 210, a value field 212, and an optional do-not-predict field 214. The program counter field 210 for each entry 208(0)-208(X) may be used to store the address 206 of the literal load instruction 202 that is detected by the instruction processing circuit 102. The value field 212 may store a predicted literal load value based on a literal load value loaded by the literal load instruction 202 associated with the address 206 in the program counter field 210. In some aspects, each entry 208(0)-208(X) may also include the do-not-predict field 214.

As seen in FIGS. 2A-2C, the data cache 110 is made up of entries 216(0)-216(Z), each comprising an address field 218 and a value field 220. Each of the entries 216(0)-216(Z) corresponds to a value retrieved during a previous execution of a load instruction. In this regard, the address field 218 stores an address of the previously retrieved value, while the value field 220 stores a copy of the value.

The constant cache 132 shown in FIGS. 2A-2C comprises entries 222(0)-222(Y). Each of the entries 222(0)-222(Y) includes a register field 224 and a value field 226. The register field 224 of each entry 222(0)-222(Y) indicates one of the registers 120 of FIG. 1 associated with the entry 222(0)-222(Y), while the value field 226 indicates a value most recently stored in the corresponding register 120. As discussed above, the constant cache 132 may provide a quick-access mechanism providing speedier access to cached values than loading the values directly from the registers 120.

Referring now to FIG. 2A, communications flows in some aspects for establishing an entry 208(X) in the literal load prediction table 104 are illustrated. As the instruction processing circuit 102 processes the instruction stream 200 for the first time, a first instance of the literal load instruction 202 is detected. As indicated by arrow 228, the instruction processing circuit 102 checks the literal load prediction table 104 to determine whether the address 206 of the literal load instruction 202 (i.e., the hexadecimal value 0x400) may be found in any of the entries 208(0)-208(X). The instruction processing circuit 102 does not find the address 206 in the entries 208(0)-208(X), and thus, in response to the “miss,” continues conventional processing of the literal load instruction 202.

Upon execution of the literal load instruction 202, the entry 216(0) of the data cache 110 is populated with an actual literal load value 230 loaded by the literal load instruction 202 (here, the hexadecimal value 0x1234). As indicated by arrow 232, the instruction processing circuit 102 accesses the entry 216(0) of the data cache 110, and obtains the actual literal load value 230. The instruction processing circuit 102 next generates the entry 208(X) in the literal load prediction table 104 based on the actual literal load value 230, as indicated by arrow 234. The address 206 of the literal load instruction 202 will be stored in the program counter field 210 of the entry 208(X), while the actual literal load value 230 will be stored as a predicted literal load value in the value field 212 of the entry 208(X). The actual literal load value 230 loaded into register R₀ by the literal load instruction 202 is then forwarded to the dependent instruction 204 using conventional mechanisms, as indicated by arrow 236.

FIG. 2B illustrates the use of the entry 208(X) of the literal load prediction table 104 for providing a predicted literal load value 238 to the dependent instruction 204. As seen in FIG. 2B, the address 206 of the literal load instruction 202 has been stored in the program counter field 210 of the entry 208(X), while the actual literal load value 230 of FIG. 2A has been stored as the predicted literal load value 238 in the value field 212 of the entry 208(X). In the example of FIG. 2B, a do-not-predict indicator 239 is also stored in the entry 208(X), with the do-not-predict indicator 239 unset (thus indicating that the entry 208(X) may be used to predict literal load values). The instruction processing circuit 102 now processes the instruction stream 200 again, and detects a second instance of the literal load instruction 202. As indicated by arrow 240, the instruction processing circuit 102 checks the literal load prediction table 104 to determine whether the address 206 is found in any of the entries 208(0)-208(X), and this time locates the entry 208(X).

In response, the instruction processing circuit 102 assigns the predicted literal load value 238 provided by the entry 208(X) to the entry 222(0) in the constant cache 132 corresponding to register R₀, as indicated by arrow 242. The predicted literal load value 238 is then provided to the dependent instruction 204 via the constant cache 132, as indicated by arrow 244. In this manner, the dependent instruction 204 is able to receive the predicted literal load value 238 while incurring no load:use penalty.

To verify that no misprediction occurred, the instruction processing circuit 102 accesses the entry 216(0) of the data cache 110 upon execution of the literal load instruction 202, and obtains the actual literal load value 230, as indicated by arrow 246. The instruction processing circuit 102 may then determine whether the predicted literal load value 238 provided by the literal load prediction table 104 matches the actual literal load value 230 loaded by the literal load instruction 202. In the example of FIG. 2B, the actual literal load value 230 and the predicted literal load value 238 match, and thus prediction was successful.

To illustrate handling of a misprediction in some aspects of the instruction processing circuit 102, FIG. 2C is provided. In FIG. 2C, it is assumed that the entry 216(0) in the data cache 110 has been updated to reflect a new actual literal load value 230 of 0x5678. As the instruction processing circuit 102 processes the instruction stream 200 again, the literal load instruction 202 is detected. The instruction processing circuit 102 checks the literal load prediction table 104 to determine whether the address 206 is found in any of the entries 208(0)-208(X), and locates the entry 208(X), as indicated by arrow 248. As in FIG. 2B, the instruction processing circuit 102 assigns the predicted literal load value 238 provided by the entry 208(X) to the entry 222(0) in the constant cache 132 corresponding to register R₀, as indicated by arrow 250. The predicted literal load value 238 is then provided to the dependent instruction 204 via the constant cache 132, as indicated by arrow 252.

Upon execution of the literal load instruction 202, the instruction processing circuit 102 accesses the entry 216(0) of the data cache 110, and obtains the actual literal load value 230, as indicated by arrow 254. The instruction processing circuit 102 then determines that the predicted literal load value 238 provided by the literal load prediction table 104 does not match the actual literal load value 230 loaded by the literal load instruction 202. A misprediction has thus been detected.

In response to the misprediction, the instruction processing circuit 102 initiates a misprediction recovery. In the example of FIG. 2C, operations for initiating the misprediction recovery include updating the predicted literal load value 238 in the entry 208(X) of the literal load prediction table 104 to store the actual literal load value 230 resulting from execution of the literal load instruction 202 (as indicated by arrow 256). In this manner, the actual literal load value 230 may be provided to future instances of the literal load instruction 202 detected by the instruction processing circuit 102. It is to be noted that, in some aspects, different and/or additional operations may be carried out as part of the misprediction recovery, which are discussed in greater detail below with respect to FIG. 4.

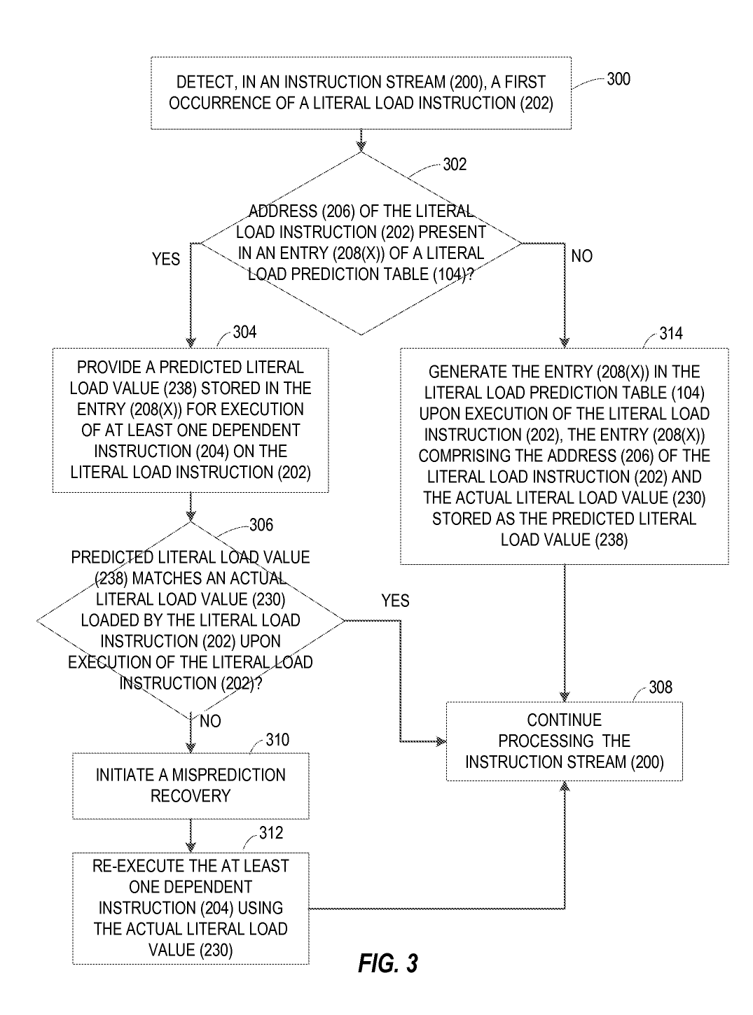

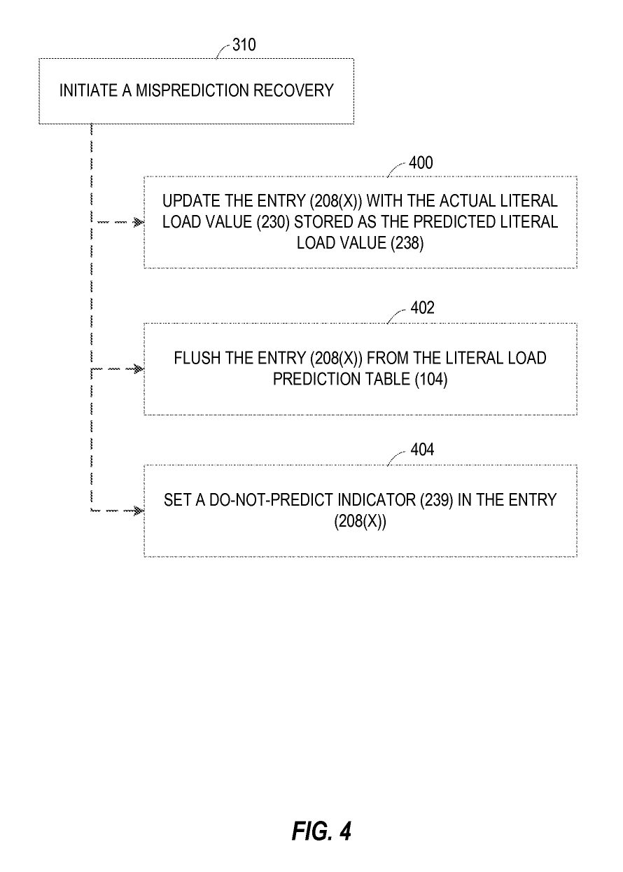

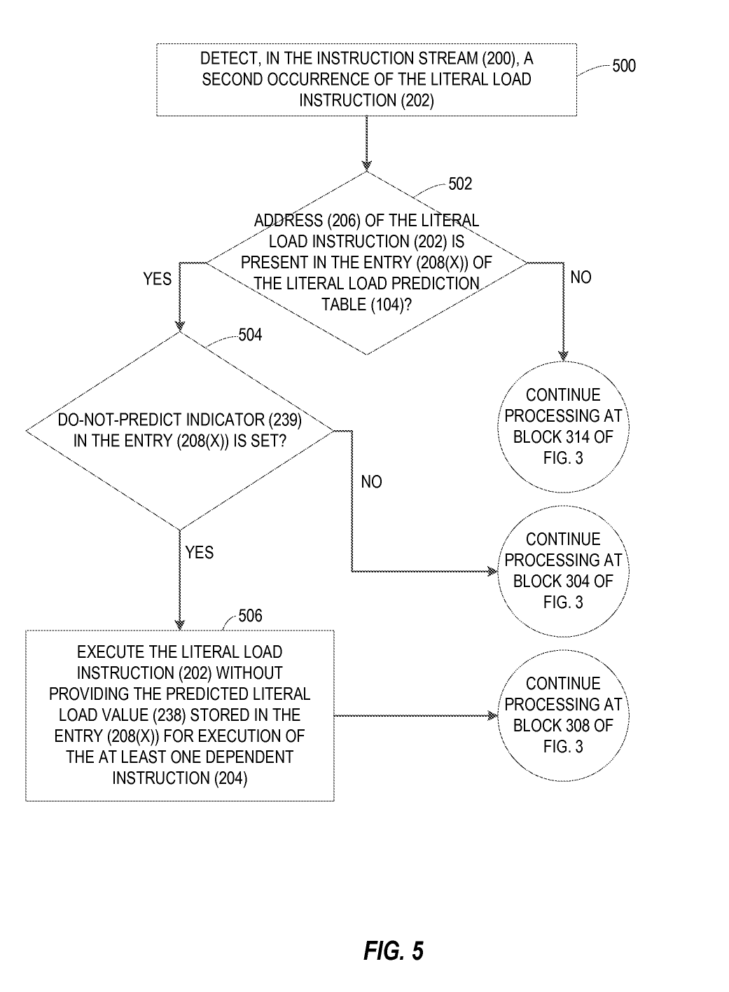

FIG. 3 is a flowchart illustrating exemplary operations for predicting literal load values and detecting mispredictions using the literal load prediction table 104 of FIG. 1. For the sake of clarity, elements of FIGS. 1 and 2A-2C are referenced in describing FIG. 3. Operations in FIG. 3 begin with the instruction processing circuit 102 of FIG. 1 detecting, in the instruction stream 200, a first occurrence of the literal load instruction 202 (block 300). Detecting the literal load instruction 202 may be accomplished by, for example, recognizing an idiomatic form of a load instruction in the instruction stream 200.

The instruction processing circuit 102 next determines whether the address 206 of the literal load instruction 202 is present in an entry 208(X) of the literal load prediction table 104 (block 302). If so, the instruction processing circuit 102 provides a predicted literal load value 238 stored in the entry 208(X) for execution of at least one dependent instruction 204 on the literal load instruction 202 (block 304). The dependent instruction 204 thus may receive the predicted literal load value 238 without incurring a load:use penalty.

To check for mispredicted literal load values, the instruction processing circuit 102 then determines whether the predicted literal load value 238 matches an actual literal load value 230 loaded by the literal load instruction 202 upon execution of the literal load instruction 202 (block 306). If the predicted literal load value 238 and the actual literal load value 230 match, the instruction processing circuit 102 continues process the instruction stream 200 (block 308). However, if a mismatch between the predicted literal load value 238 and the actual literal load value 230 is detected, the instruction processing circuit 102 initiates a misprediction recovery (block 310). The at least one dependent instruction 204 may then be re-executed using the actual literal load value 230 (block 312), and processing resumes at block 308.

If, at decision block 302, the instruction processing circuit 102 determines that the address 206 of the literal load instruction 202 is not present in an entry 208(X) of the literal load prediction table 104, the instruction processing circuit 102 generates the entry 208(X) in the literal load prediction table 104 upon execution of the literal load instruction 202 (block 314). The entry 208(X) comprising the address 206 of the literal load instruction 202, and the actual literal load value 230 stored as the predicted literal load value 238. Processing then resumes at block 308.

To illustrate exemplary operations for initiating a misprediction recovery in some aspects of the instruction processing circuit 102 of FIG. 1, FIG. 4 is provided. Elements of FIGS. 1 and 2A-2C are referenced in describing FIG. 4 for the sake of clarity. As seen in FIG. 3, the instruction processing circuit 102 may initiate a misprediction recovery in response to detecting a mispredicted literal load value (block 310 from FIG. 3). In some aspects, initiating the misprediction recovery may comprise updating the entry 208(X) with the actual literal load value 230 stored as the predicted literal load value 238 (block 400). This may enable the instruction processing circuit 102 to provide a corrected predicted literal load value 238 in response to detecting subsequent instances of the literal load instruction 202.

Some aspects may provide that initiating a misprediction recovery includes flushing the entry 208(X) from the literal load prediction table 104 (block 402). As non-limiting examples, flushing the entry 208(X) may comprise deleting or deallocating the entry 208(X) from the literal load prediction table 104, or otherwise indicating that the entry 208(X) is available to be written. Flushing the entry 208(X) may thus create free space in the literal load prediction table 104 for more frequently encountered literal load instructions 202.

According to some aspects of the instruction processing circuit 102, initiating a misprediction recovery may include setting a do-not-predict indicator 239 in the entry 208(X) (block 404). In such aspects, the do-not-predict indicator 239 is set to indicate that literal load value prediction should not be carried out for subsequent instances of the literal load instruction 202. This may be useful in circumstances in which, for example, a particular load instruction may be repeatedly detected as a literal load instruction 202, but is known to load different values at different points during execution of a computer program. By employing the do-not-predict indicator 239, the instruction processing circuit 102 may avoid an unnecessary expenditure of processing cycles in making literal load value predictions that are unlikely to be correct.

In this regard, FIG. 5 illustrates operations for using the do-not-predict indicator 239 of the literal load prediction table 104 of FIG. 1. For the sake of clarity, elements of FIGS. 1 and 2A-2C are referenced in describing FIG. 5. In FIG. 5, operations begin with the instruction processing circuit 102 of FIG. 1 detecting, in the instruction stream 200, a second occurrence of the literal load instruction 202 (block 500). In response, the instruction processing circuit 102 determines whether the address 206 of the literal load instruction 202 is present in the entry 208(X) of the literal load prediction table 104 (block 502). If the address 206 is not found, processing resumes at block 314 of FIG. 3.

If the instruction processing circuit 102 determines at block 502 that the address 206 is found in the entry 208(X), the instruction processing circuit 102 next determines whether the do-not-predict indicator 239 in the entry 208(X) is set (block 504). If not, processing resumes at block 304 of FIG. 3. However, if the do-not-predict indicator 239 is set, the instruction processing circuit 102 executes the literal load instruction 202 without providing the predicted literal load value 238 stored in the entry 208(X) for execution of the at least one dependent instruction 204 (block 506). Processing then continues at block 308 of FIG. 3.

Predicting literal load values using a literal load prediction table according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

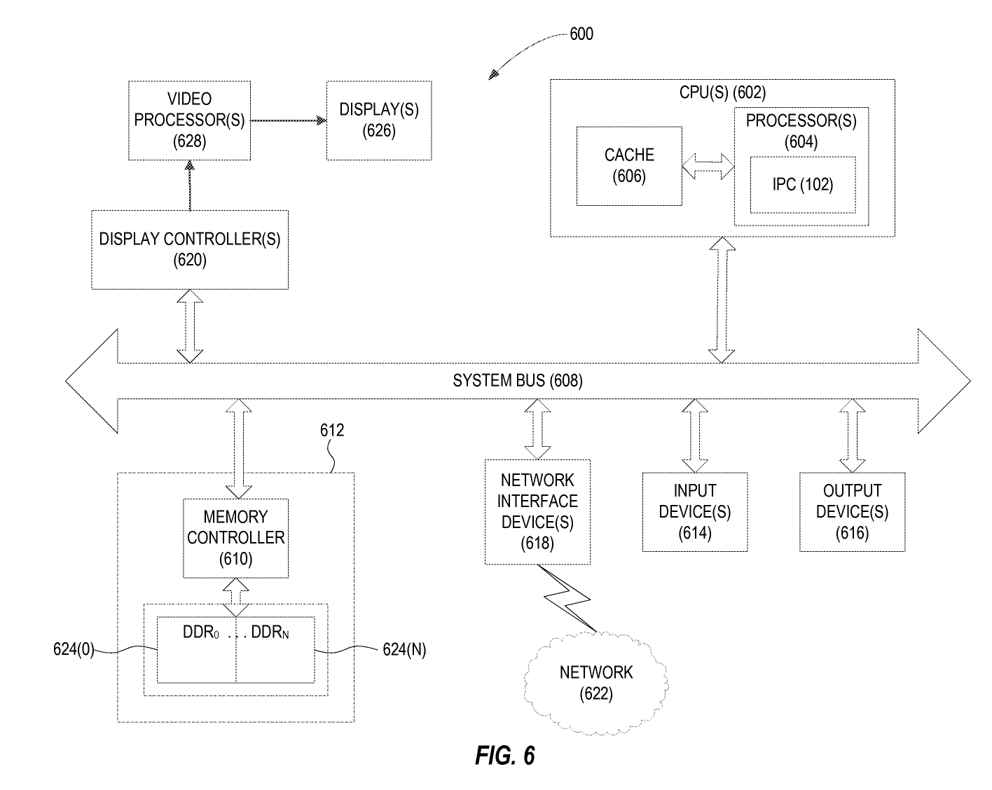

In this regard, FIG. 6 illustrates an example of a processor-based system 600 that can employ the instruction processing circuit 102 illustrated in FIGS. 1 and 2A-2C. In this example, the processor-based system 600 includes one or more central processing units (CPUs) 602, each including one or more processors 604. The one or more processors 604 may include the instruction processing circuit (IPC) 102 of FIGS. 1 and 2A-2C. The CPU(s) 602 may be a master device. The CPU(s) 602 may have cache memory 606 coupled to the processor(s) 604 for rapid access to temporarily stored data. The CPU(s) 602 is coupled to a system bus 608 and can intercouple master and slave devices included in the processor-based system 600. As is well known, the CPU(s) 602 communicates with these other devices by exchanging address, control, and data information over the system bus 608. For example, the CPU(s) 602 can communicate bus transaction requests to a memory controller 610 as an example of a slave device.

Other master and slave devices can be connected to the system bus 608. As illustrated in FIG. 6, these devices can include a memory system 612, one or more input devices 614, one or more output devices 616, one or more network interface devices 618, and one or more display controllers 620, as examples. The input device(s) 614 can include any type of input device, including but not limited to input keys, switches, voice processors, etc. The output device(s) 616 can include any type of output device, including but not limited to audio, video, other visual indicators, etc. The network interface device(s) 618 can be any devices configured to allow exchange of data to and from a network 622. The network 622 can be any type of network, including but not limited to a wired or wireless network, a private or public network, a local area network (LAN), a wide local area network (WLAN), and the Internet. The network interface device(s) 618 can be configured to support any type of communications protocol desired. The memory system 612 can include one or more memory units 624(0-N).

The CPU(s) 602 may also be configured to access the display controller(s) 620 over the system bus 608 to control information sent to one or more displays 626. The display controller(s) 620 sends information to the display(s) 626 to be displayed via one or more video processors 628, which process the information to be displayed into a format suitable for the display(s) 626. The display(s) 626 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. An instruction processing circuit configured to:
detect, in an instruction stream, a first occurrence of a literal load instruction;
determine whether an address of the literal load instruction is present in an entry of a literal load prediction table; and
responsive to determining that the address of the literal load instruction is present in the entry:
provide a predicted literal load value stored in the entry for execution of at least one dependent instruction on the literal load instruction;
determine, upon execution of the literal load instruction, whether the predicted literal load value matches an actual literal load value loaded by the literal load instruction; and
responsive to determining that the predicted literal load value does not match the actual literal load value:
initiate a misprediction recovery; and
re-execute the at least one dependent instruction using the actual literal load value.

2. The instruction processing circuit of claim 1, further configured to:
responsive to determining that the address of the literal load instruction is not present in the entry of the literal load prediction table, generate the entry in the literal load prediction table upon execution of the literal load instruction, the entry comprising the address of the literal load instruction and the actual literal load value stored as the predicted literal load value.

3. The instruction processing circuit of claim 1, configured to initiate the misprediction recovery by updating the entry with the actual literal load value stored as the predicted literal load value.

4. The instruction processing circuit of claim 1, configured to initiate the misprediction recovery by flushing the entry from the literal load prediction table.

5. The instruction processing circuit of claim 1, configured to initiate the misprediction recovery by setting a do-not-predict indicator in the entry.

6. The instruction processing circuit of claim 5, further configured to:
detect, in the instruction stream, a second occurrence of the literal load instruction;
determine whether the address of the literal load instruction is present in the entry of the literal load prediction table; and
responsive to determining that the address of the literal load instruction is present in the entry:
determine whether the do-not-predict indicator in the entry is set; and
responsive to determining that the do-not-predict indicator in the entry is set, execute the literal load instruction without providing the predicted literal load value stored in the entry for execution of the at least one dependent instruction.

7. The instruction processing circuit of claim 1 integrated into an integrated circuit (IC).

8. The instruction processing circuit of claim 1 integrated into a device selected from the group consisting of: a set top box; an entertainment unit; a navigation device; a communications device; a fixed location data unit; a mobile location data unit; a mobile phone; a cellular phone; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; and a portable digital video player.

9. An instruction processing circuit comprising:
a means for detecting, in an instruction stream, a first occurrence of a literal load instruction;
a means for determining whether an address of the literal load instruction is present in an entry of a literal load prediction table;
a means for, responsive to determining that the address of the literal load instruction is present in the entry, providing a predicted literal load value stored in the entry for execution of at least one dependent instruction on the literal load instruction;
a means for, further responsive to determining that the address of the literal load instruction is present in the entry, determining, upon execution of the literal load instruction, whether the predicted literal load value matches an actual literal load value loaded by the literal load instruction;
a means for, responsive to determining that the predicted literal load value does not match the actual literal load value, initiating a misprediction recovery; and
a means for, further responsive to determining that the predicted literal load value does not match the actual literal load value, re-executing the at least one dependent instruction using the actual literal load value.

10. A method for predicting values of literal loads, comprising:
detecting, in an instruction stream, a first occurrence of a literal load instruction;
determining whether an address of the literal load instruction is present in an entry of a literal load prediction table; and
responsive to determining that the address of the literal load instruction is present in the entry:
providing a predicted literal load value stored in the entry for execution of at least one dependent instruction on the literal load instruction;
determining, upon execution of the literal load instruction, whether the predicted literal load value matches an actual literal load value loaded by the literal load instruction; and
responsive to determining that the predicted literal load value does not match the actual literal load value:
initiating a misprediction recovery; and
re-executing the at least one dependent instruction using the actual literal load value.

11. The method of claim 10, further comprising:
responsive to determining that the address of the literal load instruction is not present in the entry of the literal load prediction table, generating the entry in the literal load prediction table upon execution of the literal load instruction, the entry comprising the address of the literal load instruction and the actual literal load value stored as the predicted literal load value.

12. The method of claim 10, wherein initiating the misprediction recovery comprises updating the entry with the actual literal load value stored as the predicted literal load value.

13. The method of claim 10, wherein initiating the misprediction recovery comprises flushing the entry from the literal load prediction table.

14. The method of claim 10, wherein initiating the misprediction recovery comprises setting a do-not-predict indicator in the entry.

15. The method of claim 14, further comprising:
detecting, in the instruction stream, a second occurrence of the literal load instruction;
determining whether the address of the literal load instruction is present in the entry of the literal load prediction table; and
responsive to determining that the address of the literal load instruction is present in the entry:
determining whether the do-not-predict indicator in the entry is set; and
responsive to determining that the do-not-predict indicator in the entry is set, executing the literal load instruction without providing the predicted literal load value stored in the entry for execution of the at least one dependent instruction.

16. A non-transitory computer-readable medium having stored thereon computer-executable instructions to cause a processor to:
detect, in an instruction stream, a first occurrence of a literal load instruction;
determine whether an address of the literal load instruction is present in an entry of a literal load prediction table; and
responsive to determining that the address of the literal load instruction is present in the entry:
provide a predicted literal load value stored in the entry for execution of at least one dependent instruction on the literal load instruction;
determine, upon execution of the literal load instruction, whether the predicted literal load value matches an actual literal load value loaded by the literal load instruction; and
responsive to determining that the predicted literal load value does not match the actual literal load value:
initiate a misprediction recovery; and
re-execute the at least one dependent instruction using the actual literal load value.

17. The non-transitory computer-readable medium of claim 16 having stored thereon computer-executable instructions to further cause the processor to:
responsive to determining that the address of the literal load instruction is not present in the entry of the literal load prediction table, generate the entry in the literal load prediction table upon execution of the literal load instruction, the entry comprising the address of the literal load instruction and the actual literal load value stored as the predicted literal load value.

18. The non-transitory computer-readable medium of claim 16 having stored thereon computer-executable instructions to cause the processor to initiate the misprediction recovery by updating the entry with the actual literal load value stored as the predicted literal load value.

19. The non-transitory computer-readable medium of claim 16 having stored thereon computer-executable instructions to cause the processor to initiate the misprediction recovery by flushing the entry from the literal load prediction table.

20. The non-transitory computer-readable medium of claim 16 having stored thereon computer-executable instructions to cause the processor to initiate the misprediction recovery by setting a do-not-predict indicator in the entry.

21. The non-transitory computer-readable medium of claim 20 having stored thereon computer-executable instructions to further cause the processor to:
detect, in the instruction stream, a second occurrence of the literal load instruction;
determine whether the address of the literal load instruction is present in the entry of the literal load prediction table; and
responsive to determining that the address of the literal load instruction is present in the entry:
determine whether the do-not-predict indicator in the entry is set; and
responsive to determining that the do-not-predict indicator in the entry is set, execute the literal load instruction without providing the predicted literal load value stored in the entry for execution of the at least one dependent instruction.
